(19) United States
(12) Patent Application Publication
(10) Pub. No.: US 2010/0193311 A1
(43) Pub. Date: Aug. 5, 2010

(54) Enhanced Brake Booster Vacuum Support

(75) Inventors: Scott Calnek, Whitby (CA); Terry W. Ostan, Whitby (CA)

Correspondence Address: Keefe and Associates, 24405 Gratiot Avenue, Eastpointe, MI, 48021, US

(73) Assignee: GM GLOBAL TECHNOLOGY OPERATIONS, INC., DETROIT, MI (US)

(21) Appl. No.: 12/362,719

(22) Filed: Jan. 30, 2009

(51) Int. Cl. B60T 13/56; B60T 13/57; B60T 13/68

(52) U.S. Cl. 188/357; 91/514; 91/443; 60/397; 60/547.2

(57) ABSTRACT

An apparatus and method for providing enhanced vacuum to a brake booster of a braking system under certain operational conditions. Vacuum is stored in a reservoir and is controllably released to the brake booster to provide a brake booster vacuum level of at least a predetermined vacuum level threshold in order to avoid brake pedal performance issues being perceived by the driver of motor vehicles utilizing engines utilizing a supplemental brake assist system under conditions where the brake booster vacuum level is less than the predetermined vacuum level threshold.

### TECHNICAL FIELD

The present invention relates to motor vehicle brake systems incorporating vacuum brake boosters. More particularly, the present invention relates to a method of enhancing brake booster vacuum for motor vehicles utilizing internal combustion engines, particularly, but not limited to, spark ignition direct injection (SIDI) engines.

### BACKGROUND OF THE INVENTION

Motor vehicles utilizing present day spark ignition direct injection (SIDI) engines may under certain circumstances produce a lesser than optimal vacuum level. Correspondingly, this may result in a lower brake booster vacuum level. When the brake booster vacuum level is less than a minimum vacuum level threshold, changes in brake pedal performance can be discerned by the driver (i.e., harder than normal brake pedal feel, pedal pulsation, etc.). There are many contributors to low powertrain vacuum generation, however the most predominate, in relation to brake booster vacuum levels, are engine cold start and high altitude driving. During these types of events, brake booster vacuum might not achieve the minimum vacuum level threshold, and, therefore, brake pedal performance may be less than optimal. For example, during cold start conditions, which occurs when the vehicle has been inactive for a period of time, low vacuum levels can be seen for as long as 60 seconds. After such time, the vacuum level will achieve or exceed the minimum vacuum level threshold.

As used herein, vacuum levels, such as 30 kPa, are gage pressures as measured by a vacuum gage. That is, a vacuum gage pressure of 0 kPa corresponds to atmospheric pressure, and a vacuum level of 30 kPa is 30 kPa below atmospheric pressure. Thus, as used herein, larger or increased vacuum levels represent greater (i.e., more) vacuum below atmospheric pressure than that of lower or decreased vacuum levels. That is, a vacuum level of 30 kPa represents a larger or increased (i.e., greater or more) vacuum than a vacuum level of 0 kPa. As further used herein (see FIG. 2C), “threshold α” refers to the minimum brake booster vacuum level threshold that provides acceptable brake pedal performance, wherein by way of nonlimiting example, threshold α may be a vacuum level of, depending on the vehicle application, approximately 30 kPa. A “level β” is defined as the normal (i.e., operational) brake booster vacuum level, always being greater than threshold α, wherein level β may be a vacuum level of, by way of nonlimiting example depending on the vehicle application, approximately 67 kPa.

Whenever the vacuum level of the engine vacuum is above the vacuum level of the brake booster, vacuum of the engine vacuum is provided to the brake booster automatically by valving.

Motor vehicles that experience low vacuum conditions may incorporate a Low Vacuum Brake Assist (LVBA). Generally, LVBA functionality resides in the Electronic Brake Control Module (EBCM). This feature provides a hydraulic supplement to simulate brake booster function. LVBA does not produce or supply vacuum to the brake booster and, thus, does not enhance brake booster vacuum.

Continental Teves AG and Co. of Frankfurt, Germany, currently offers an implementation of LVBA. Contained within the features, generally referred to as Optimized Hydraulic Braking (OHB), this system manipulates the hydraulic pressure to compensate for low brake booster vacuum conditions.

By way of further example, General Motors Corporation of Detroit, Mich., utilizes, in several of its vehicles, an Electronic Brake Control Module (EBCM) which supports Low Vacuum Brake Assist (LVBA) functionality. In practice, without the utilization of a supplemental brake assist system, such as the Low Vacuum Brake Assist (LVBA), a brake booster vacuum level equivalent to level β would be required for normal operation without brake pedal performance degradation. Also, in conjunction with the utilization of a supplemental brake assist system, such as the Low Vacuum Brake Assist (LVBA), a brake booster vacuum level between threshold α and level β also results in normal operation without brake pedal performance degradation. The amount of hydraulic supplement provided by an LVBA system decreases in a predetermined manner as the brake booster vacuum increases. The greatest assist would be seen when the booster vacuum level is zero, gradually decreasing until a predetermined threshold is achieved. However, if the brake booster vacuum is below threshold α, then brake pedal performance degradation may occur even with the utilization of a supplemental brake assist system, such as the Low Vacuum Brake Assist (LVBA).

Current industry solutions to deal with “near zero” vacuum booster conditions include auxiliary electric vacuum pumps or mechanical vacuum pumps to supplement the brake booster vacuum, however these are expensive, heavy and add significant complexity. Another alternative is the use of a six piston premium electronic brake control module (EBCM) in conjunction with the LVBA functionality. This configuration improves the low vacuum brake booster pedal feel, but is also expensive.

What is needed in the art, therefore, is a more economical, lightweight and reliable method to enhance brake booster vacuum to achieve a vacuum greater than or equal to a predetermined vacuum level threshold in motor vehicles utilizing internal combustion engines, particularly, but not limited to, SIDI engines, under the above stated conditions.

### SUMMARY OF THE INVENTION

The present invention is a method to enhance brake booster vacuum utilizing internal combustion engines, particularly, but not limited to, SIDI engines, incorporating a supplemental brake assist system, such as the above described Low Vacuum Brake Assist (LVBA), under low brake booster vacuum level conditions, as for example previously described, wherein if the brake booster vacuum level is below a predetermined vacuum level threshold, threshold α, by way of nonlimiting example, depending on the vehicle application, a vacuum level of approximately 30 kPa, to thereby mitigate less than optimal brake pedal performance as may otherwise be perceived by the vehicle driver.

According to the method and apparatus of the present invention, vacuum of an internal combustion engine vacuum is stored in a reservoir, for example in at least one canister, and the vacuum is selectively released to the brake booster to enhance its vacuum level.

Responsive to an electronic controller detecting the vacuum level of the brake booster being below a predetermined vacuum level threshold, denoted as a “threshold α”, which is a minimum vacuum level at which the brake booster provides acceptable brake pedal performance, the vacuum of the vacuum reservoir is controllably released through valving to the brake booster to provide an enhanced brake booster vacuum level of, preferably, at least the predetermined vacuum level threshold, in order to avoid brake pedal performance degradation being perceived by the vehicle driver in motor vehicles incorporating a supplemental brake assist system, such as the Low Vacuum Brake Assist (LVBA).

Whenever the vacuum level of the engine vacuum is above the vacuum level of the vacuum reservoir, vacuum of the engine vacuum is released to the vacuum reservoir automatically by the valving.

As is conventional with respect to brake boosters, whenever the vacuum level of the engine vacuum is above the vacuum level of the brake booster, vacuum of the engine vacuum is provided to the brake booster automatically by the valving.

Accordingly, it is an object of the present invention to enhance brake booster vacuum level in motor vehicles incorporating a supplemental brake assist system, such as the Low Vacuum Brake Assist (LVBA), in order to provide a brake booster vacuum level greater than or equal to a predetermined vacuum level threshold, threshold α, under low brake booster vacuum conditions, as previously described.

This and additional objects, features and advantages of the present invention will become clearer from the following specification of a preferred embodiment.

### BRIEF DESCRIPTION OF THE DRAWINGS

FIG. 1 is a prior art plot of brake booster vacuum level versus time from a cold start for a conventional SIDI engine.

FIG. 2A is a block diagram of an implementation example according to the present invention.

FIG. 2B is a diagrammatic example of a vacuum check valve.

FIG. 2C is a vacuum level diagram.

FIG. 3 is a flow chart of an algorithm of a method to enhance brake booster vacuum level in motor vehicles utilizing, by way of example, SIDI engines incorporating a supplemental brake assist system under low brake booster vacuum conditions according to the present invention.

FIG. 4 exemplifies a graph of test plots of vacuum levels versus time of the vacuum reservoir, brake booster, and SIDI engine vacuum from a cold start according to the present invention.

### DESCRIPTION OF THE PREFERRED EMBODIMENT

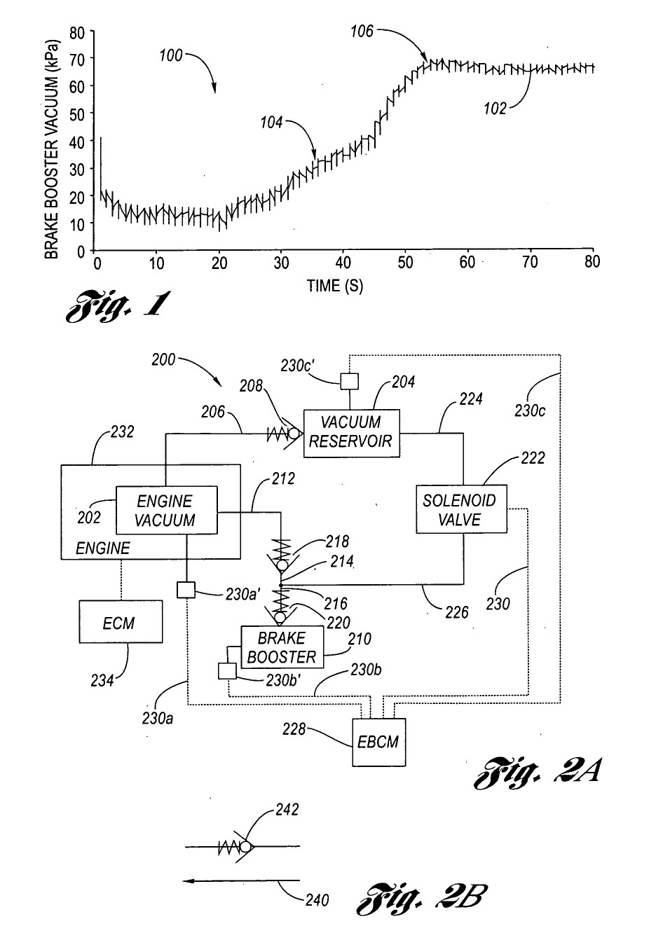

Referring now to the Drawings, FIG. 1 is a plot 100 of brake booster vacuum versus time from a cold start for a typical SIDI engine according to the prior art. In FIG. 1, the predetermined vacuum level threshold is threshold α, as for nonlimiting example approximately 30 kPa, depicted at point 104 of graph 102, whereat the time required to achieve the brake booster vacuum level of threshold α is, approximately, 37 seconds. From point 106 of graph 102 of FIG. 1, the time required to achieve a brake booster vacuum level of level β, as for nonlimiting example approximately 67 kPa is, approximately, 55 seconds. In general during a cold start event, approximately 30 to 60 seconds are necessary for present SIDI engines to produce a vacuum level for the brake booster greater than or equal to the predetermined vacuum level threshold, threshold α.

As stated hereinabove, vacuum levels, such as 30 kPa, are gage pressures as measured by a vacuum gage. That is, a vacuum gage pressure of 0 kPa corresponds to atmospheric pressure, and a vacuum level of 30 kPa is 30 kPa below atmospheric pressure. Thus, as used herein, larger or increased vacuum levels represent greater (i.e., more) vacuum below atmospheric pressure than that of lower or decreased vacuum levels. That is, a vacuum level of 30 kPa represents a larger or increased (i.e., greater or more) vacuum than a vacuum level of 0 kPa.

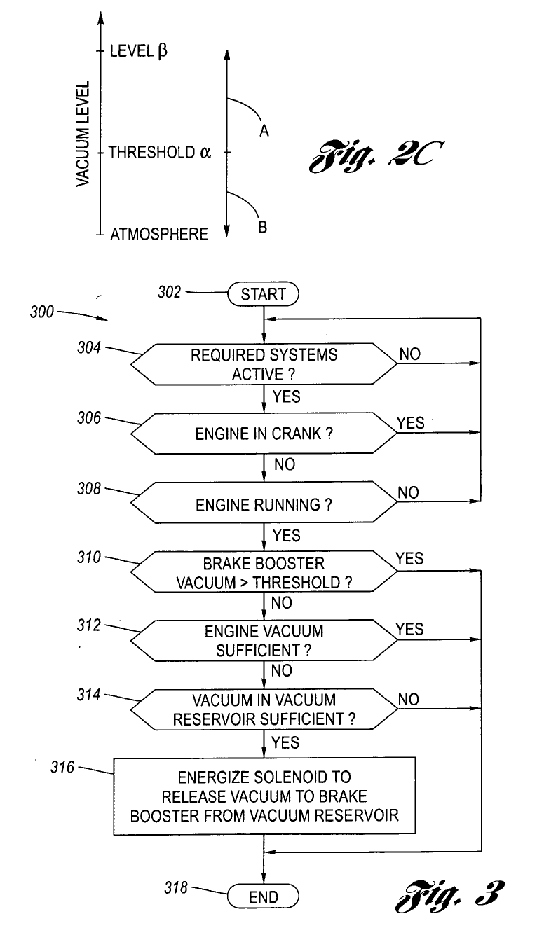

As shown at FIG. 2C, threshold α refers to the minimum brake booster vacuum level that provides acceptable brake pedal performance, and level β is defined as the normal (i.e., operational) brake booster vacuum level, always being greater than threshold α. Accordingly, if the vacuum level of the brake booster is in vacuum level range A, then an acceptable brake pedal performance is provided, but if vacuum level of the brake booster is in vacuum level range B, then an acceptable brake performance may not be provided.

FIG. 2A is a block diagram 200 of an implementation example according to the present invention. Block 202 represents an engine vacuum of an internal combustion engine 232 supplying vacuum to a vacuum reservoir 204 via a vacuum line 206 through a vacuum check valve 208. Block 202 simultaneously supplies vacuum to a brake booster 210 via vacuum lines 212, 214, and 216 through vacuum check valves 218 and 220. A normally closed state solenoid valve 222 is used to selectively supply vacuum to the brake booster 210 from the vacuum reservoir 204, when in its open state, by energization of the solenoid thereof, via vacuum lines 224, 226, and 216 through the vacuum check valve 220. An Electronic Brake Control Module (EBCM) 228, known in the art, incorporates software to control release of vacuum from the vacuum reservoir 204 to the brake booster 210 via control line 230.

By way merely of nonlimiting example, data lines 230a, 230b and 230c provide the EBCM 228 with vacuum pressure data from the engine vacuum 202, the brake booster 210 and the vacuum reservoir 204, via a selected number of vacuum sensors 230a′, 230b′, and 230c′, which may or may not be located in the vacuum check valves, and wherein the selected number may be more or less than that shown; for example, there may be only two interfaced, for example, with the vacuum reservoir and the brake booster).

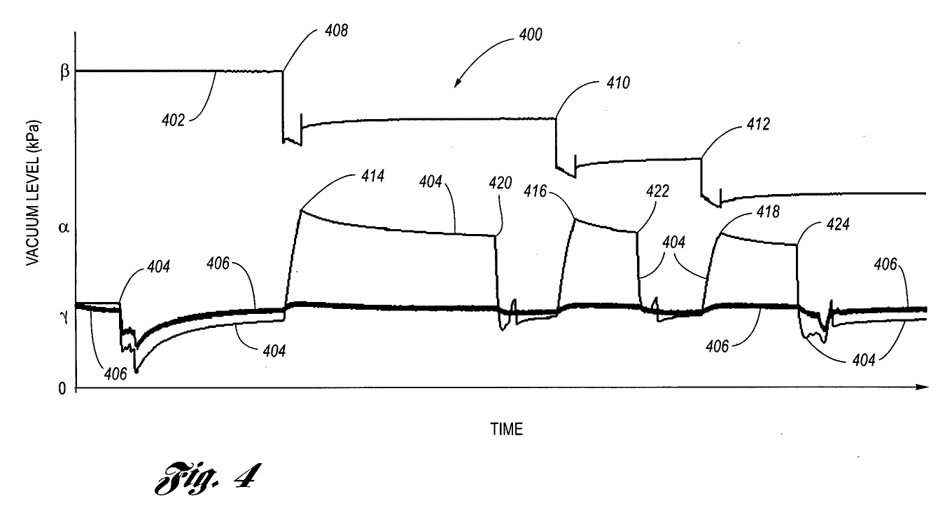

An example of an algorithm defining the control method and software incorporated in the EBCM 228 to control release of vacuum from the vacuum reservoir 204 to the brake booster 210 is later described in detail with respect to FIG. 3.

As is conventional with respect to brake boosters, whenever the vacuum level of the engine vacuum 202 is above the vacuum level of the brake booster 210, vacuum of the engine vacuum is provided (released) to the brake booster automatically by the vacuum lines 212, 214 and 216 through the vacuum check valves 218 and 220, wherein the engine vacuum is provided to the brake booster independently of the vacuum reservoir 204 and solenoid valve 222.

FIG. 2B depicts the direction of airflow 240 through vacuum check valves 208, 218, and 220 summarily represented by vacuum check valve 242. Vacuum flow is in a direction opposite to direction 240.

FIG. 3 is a flow chart of an algorithm 300 representing an example of a method to enhance brake booster vacuum in motor vehicles utilizing engines incorporating a supplemental brake assist system, such as the Low Vacuum Brake Assist (LVBA), under low brake booster vacuum conditions according to the present invention.

The algorithm 300 refers to FIGS. 2A and 2B, wherein system components include, for example, the EBCM 228, the vacuum check valves 208, 218, and 220, a selected number of vacuum sensors (for example, vacuum sensors 230a′, 230b′, and 230c′), the solenoid valve 222, and an Electronic Control Module (ECM) 234.

Starting at Block 302, the algorithm proceeds to Block 304. At Block 304, when the required systems and signals are active, control passes to Block 306. At Block 306, if the engine is in crank, control returns to Block 304. Otherwise, control passes to Block 308. At Block 308, if the engine is not running, control returns to Block 304. Otherwise, control passes to Block 310. At Block 310, if brake booster 210 vacuum is greater than a predetermined vacuum level threshold, threshold α, control passes to Block 318 whereat the algorithm ends. Otherwise, control passes to Block 312. It is to be again noted that the engine operational vacuum level, level β, is greater than threshold α (that is, the gas pressure at level β is lower than the gas pressure at threshold α).

At Block 312, if engine vacuum 202 is sufficient to provide brake booster 210 with a vacuum level greater than the predetermined vacuum level threshold, threshold α, then control passes to Block 318, whereat the algorithm ends. Otherwise, control passes to Block 314. At Block 314, if the vacuum reservoir 204 cannot provide brake booster 210 a vacuum level greater than the predetermined vacuum level threshold, then control passes to Block 318, whereat the algorithm ends. Otherwise, control passes to Block 316. Vacuum level difference, derivable from the vacuum sensors, between vacuum reservoir 204 and brake booster 210 is utilized to determine, according to empirical testing or theoretical analysis, whether the vacuum reservoir can provide the brake booster a vacuum level greater than the predetermined vacuum level threshold.

At Block 316, the solenoid of the solenoid valve 222 is energized (to its open state) by the EBCM 228 to supply enhanced vacuum to the brake booster 210 from the vacuum reservoir 204. Control then passes to Block 318 whereat the algorithm ends.

In FIG. 3, vacuum measurements are available from the selected number of vacuum sensors per, for example, the data lines 230a, 230b, and 230c of FIG. 2A. The EBCM 228 has, for example, incorporated therein a predetermined lookup table relating solenoid valve 222 energization time versus vacuum level differences between vacuum reservoir 204 and brake booster 210 to determine the amount of time to energize the solenoid component of solenoid valve in Block 316.

Utilizing FIGS. 2A, and 2B in conjunction with the algorithm 300 of FIG. 3, following is a description of an example of a method by which vacuum is stored in a reservoir, for example in at least one canister, and is controllably released to the brake booster to provide a brake booster vacuum of, preferably, at least a predetermined vacuum level threshold, threshold α, in order to avoid brake pedal performance degradation as perceived by the driver in motor vehicles utilizing, by way of example, SIDI engines incorporating a supplemental brake assist system, such as the Low Vacuum Brake Assist (LVBA) according to the present invention.

Under motor vehicle operating conditions, engine vacuum 202 has a vacuum level that is greater than threshold α, normally operating at approximately level β, being approximately the same vacuum level as the engine vacuum supplied to the brake booster 210 via vacuum line 212 through vacuum check valve 218 and via vacuum lines 214 and 216 through vacuum check valve 220. At this time, the solenoid valve 222 is not energized (i.e., in its closed state) by which vacuum in vacuum reservoir 204 is isolated from the brake booster. Simultaneously, with solenoid valve 222 not energized, engine vacuum 202 supplies vacuum of, approximately, the same vacuum level as engine vacuum to vacuum reservoir 204 via vacuum line 206 through vacuum check valve 208. In this regard, vacuum check valve 208 releases vacuum from the engine vacuum 202 to the vacuum reservoir only when the engine vacuum has a vacuum level exceeding the vacuum level of the vacuum reservoir (that is, when the vacuum level of the engine vacuum is further below atmospheric pressure than is the vacuum level of the vacuum reservoir).

When the vacuum level of the engine vacuum 202 is less than the vacuum level of vacuum reservoir 204, for example when the engine is turned off, vacuum check valve 208 and solenoid valve 222 prevent the release of vacuum from the vacuum reservoir, wherein at this time the solenoid valve is not energized (i.e., in its closed state). In this regard, the vacuum of the vacuum reservoir is sustainable for an extended time, for example at least two weeks.

However, as is known in the art, vacuum in brake booster 210 will, in general, be gradually released when the vacuum level in the engine vacuum 202 is less than the vacuum level in the brake booster and may be less than the predetermined vacuum level threshold the next time the engine is started. Vacuum in brake booster 210 may also be released and become less than the predetermined vacuum level threshold under other conditions such as, for example, repeated use of the brakes within a short time interval.

When the vacuum level in brake booster 210 is less than the predetermined vacuum level threshold, threshold α, and the vacuum level in vacuum reservoir 204 is greater (i.e., has a lower gas pressure) than the vacuum level in the brake booster by a predetermined amount, specified at Block 314 of the algorithm 300 of FIG. 3, then the EBCM 228 energizes the solenoid of the solenoid valve 222 (i.e., it is now in its open state), while vacuum check valve 218 prevents vacuum from being released from vacuum line 214 to vacuum line 212. The vacuum in the vacuum reservoir 204 communicates with the brake booster 210, whereby vacuum of the vacuum reservoir is released to the brake booster through the solenoid valve 222, the solenoid via vacuum lines 226 and 216, and the vacuum check valve 220. Vacuum check valve 208 prevents the release of vacuum from the vacuum reservoir 204 into vacuum line 206 if the vacuum level in the vacuum line is less (i.e., has a higher gas pressure) than the vacuum level in the vacuum reservoir. Solenoid valve 222 is energized (i.e., its open state) as previously described by the algorithm 300 at Block 316 FIG. 3 to increase the vacuum level in the brake booster 210.

An exemplar graph illustrating a method by which vacuum stored in a reservoir is controllably released to the brake booster to provide a brake booster vacuum level of at least the predetermined vacuum level threshold in order to not have a brake pedal performance degradation as perceived by the driver in a motor vehicle utilizing an engine incorporating a supplemental brake assist system, such as the Low Vacuum Brake Assist (LVBA), under conditions where the brake booster vacuum level is less than the predetermined vacuum level threshold, threshold α, is shown at FIG. 4.

FIG. 4 is a graph 400 of test plots 402, 404, and 406 of vacuum levels versus time of the vacuum reservoir, brake booster, and engine vacuum, respectively, from a cold start, according to the present invention, using a total test canister volume of 6 liters for the vacuum reservoir 204 with a motor vehicle having an SIDI engine to supply engine vacuum 202. A regulator was placed between vacuum check valves 218 and 220 to simulate a cold start condition, and a data control/recorder was used in place of the EBCM 228 for the testing. The predetermined vacuum level threshold, threshold α, in this test is approximately 30 kPa, the vacuum level in the vacuum reservoir is initially equal to level β, which in this test is approximately 67 kPa, and vacuum levels of the brake booster and the engine vacuum are initially equal to a value γ, which in this test is approximately 10 kPa, wherein value γ is less than threshold α and level β.

Points 408, 410, and 412 represent events at which vacuum is released from the vacuum reservoir to the brake booster, by which vacuum in the vacuum reservoir is reduced at each point, but remains greater than threshold α, while engine vacuum remains at value γ. As a result of the vacuum release from the vacuum reservoir, at each point 408, 410, and 412, respectively, the vacuum level of the brake booster rises from value γ to approximately threshold α, until such time when the brakes are applied at points 420, 422, and 424, respectively, at which events the vacuum level of the brake booster is again approximately value γ.

Thus, it is seen from FIG. 4 that the vacuum reservoir supplies vacuum to the brake booster to provide a brake booster vacuum level of at least the predetermined vacuum level threshold, threshold α, according to the present invention.

To those skilled in the art to which this invention appertains, the above described preferred embodiment may be subject to change or modification. Such change or modification can be carried out without departing from the scope of the invention, which is intended to be limited only by the scope of the appended claims.

1. An apparatus for providing enhanced brake booster vacuum for a braking system of a motor vehicle, said apparatus comprising:
an engine which provides an engine vacuum;
a supplemental brake assist system comprising a brake booster connected to the engine vacuum;
a vacuum reservoir;
valving interconnected with said brake booster, with said vacuum reservoir and with said engine vacuum; and
an electronic controller interfaced with said valving;
wherein responsive to said electronic controller detecting a vacuum level of the brake booster below substantially a predetermined vacuum level threshold, said valving selectively releases vacuum of the vacuum reservoir to said brake booster to thereby enhance the vacuum of the brake booster; and
wherein if a vacuum level of the engine vacuum is above that of the vacuum level of said vacuum reservoir, then the vacuum of the engine source of vacuum is provided to said vacuum reservoir.

2. The apparatus of claim 1, wherein said valving comprises:
a solenoid valve interconnected with said electronic controller, wherein responsive to said electronic controller, said solenoid valve selectively releases vacuum of the vacuum reservoir to said brake booster.

3. The apparatus of claim 2, wherein said valving further comprises:
a first check valve interconnecting said engine vacuum and said vacuum reservoir such that vacuum flows unidirectionally from said engine vacuum to said vacuum reservoir;
a second check valve interconnecting said engine vacuum, said brake booster, and said solenoid valve such that vacuum flows unidirectionally from said engine vacuum to said brake booster; and
a third check valve interconnecting said solenoid valve and said brake booster such that vacuum flows unidirectionally from said engine vacuum to said brake booster, and such that vacuum flows unidirectionally from said vacuum reservoir to said brake booster.

4. An apparatus for providing enhanced brake booster vacuum for a braking system of a motor vehicle, said apparatus comprising:
an engine which provides an engine vacuum;
a supplemental brake assist system comprising a brake booster connected to the engine vacuum;
a vacuum reservoir;
valving interconnected with said brake booster, with said vacuum reservoir and with said engine vacuum; and
an electronic controller interfaced with said valving;
wherein responsive to said electronic controller detecting a vacuum level of the brake booster below substantially a predetermined vacuum level threshold, and detecting vacuum of said vacuum reservoir is sufficient to provide a vacuum level of said brake booster of at least at substantially the predetermined vacuum level threshold, then said valving selectively releases vacuum of the vacuum reservoir to said brake booster to thereby enhance the vacuum of the brake booster; and
wherein if a vacuum level of the engine vacuum is above that of the vacuum level of said vacuum reservoir, then the vacuum of the engine source of vacuum is provided to said vacuum reservoir.

5. The apparatus of claim 4, wherein said valving comprises:
a solenoid valve interconnected with said electronic controller, wherein responsive to said electronic controller, said solenoid valve selectively releases vacuum of the vacuum reservoir to said brake booster.

6. The apparatus of claim 5, wherein said valving further comprises:
a first check valve interconnecting said engine vacuum and said vacuum reservoir such that vacuum flows unidirectionally from said engine vacuum to said vacuum reservoir;
a second check valve interconnecting said engine vacuum, said brake booster, and said solenoid valve such that vacuum flows unidirectionally from said engine vacuum to said brake booster; and
a third check valve interconnecting said solenoid valve and said brake booster such that vacuum flows unidirectionally from said engine vacuum to said brake booster, and such that vacuum flows unidirectionally from said vacuum reservoir to said brake booster.

7. A method for enhancing vacuum for a brake booster of a supplemental brake assist system of a motor vehicle braking system, comprising the steps of:
connecting an engine vacuum to a brake booster of a braking system;
selectively connecting the vacuum of the vacuum reservoir to the brake booster if the brake booster has a vacuum level below substantially a predetermined vacuum level threshold to thereby provide an enhanced vacuum to the brake booster; and
releasing the engine vacuum to the vacuum reservoir if the engine vacuum has a vacuum level above a vacuum level of said vacuum reservoir.

8. The method of claim 7, wherein said step of selectively connecting the vacuum of the vacuum reservoir to the brake booster is performed further if the vacuum of the vacuum reservoir is sufficient such that the enhanced vacuum of the brake booster is able to provide at least the predetermined vacuum level threshold in the brake booster.

9. The method of claim 8, wherein:
said step of connecting is a unidirectional flow of vacuum from the engine vacuum to the brake booster;
said step of selectively connecting the engine vacuum to the vacuum reservoir is a unidirectional flow of vacuum from the engine vacuum to the vacuum reservoir; and
said step of selectively connecting the vacuum of the vacuum reservoir to the brake booster is a unidirectional flow of vacuum from the vacuum reservoir to the brake booster and closed with respect to said engine vacuum.
